(19) United States
(12) Patent Application Publication
(10) Pub. No.: US 2021/0403843 A1
(43) Pub. Date: Dec. 30, 2021

(54) System and Method for the Production of a Physically Stable High Gravity Beer

(71) Applicant: Sandymount Technologies Corporation, Woburn, MA (US)

(72) Inventors: Ronan K. McGovern, Cambridge, MA (US); Adam M. Weiner, Cambridge, MA (US); Andrew Hunt, Wilbraham, MA (US); Paul Michael Thompson, Raleigh, NC (US)

(21) Appl. No.: 16/625,150

(22) PCT Filed: Jun. 20, 2018
(86) PCT No.: PCT/US2018/038517

§ 371 Date: Dec. 20, 2019

Related U.S. Application Data
(60) Provisional application No. 62/522,562, filed on Jun. 20, 2017.
(60) Provisional application No. 62/639,883, filed on Mar. 7, 2018.

(51) Int. Cl. C12C 11/11; C12H 6/00; C12H 1/07; C12H 1/065; C12H 1/056; B01D 61/02; B01D 61/14; B01D 61/58; B01D 61/08; B01D 61/18

(52) U.S. Cl. CPC C12C 11/11; B01D 2311/2642; C12H 1/063; C12H 1/061; C12H 1/0424; B01D 61/025; B01D 61/147; B01D 61/58; B01D 61/08; B01D 61/18; B01D 2311/08; B01D 2311/106; B01D 2311/2676; B01D 2311/2626; C12H 6/00

(57) ABSTRACT

A method of reducing haze by creating a physically stable alcoholic beverage that has been obtained via filtration and separation processes includes receiving retentate from which water has been removed, from a reverse osmosis filter system having an initial alcoholic precursor to the alcoholic beverage in a feed stream, wherein a concentration of alcohol in the retentate has reached between about 10% and 40% by volume, cooling the retentate to a temperature between about 2 degrees below a freezing point of the retentate and a freezing point of the initial alcoholic precursor to the alcoholic beverage in the feed stream, and subjecting the retentate to a clarification process that removes particles having a size of about 0.4-0.8 microns and larger to produce a clarified retentate. The clarification process includes centrifuging, filtration using a filter, and/or forming a supernate and a precipitate and then decanting the supernate.

### CROSS-REFERENCE TO RELATED APPLICATIONS

This patent application claims the benefit of U.S. Provisional Patent Appl. No. 62/522,562 filed Jun. 20, 2017 and U.S. Provisional Patent Appl. No. 62/639,883 filed Mar. 7, 2018, the disclosures of which are incorporated by reference herein in their entirety.

### TECHNICAL FIELD

The present invention relates to the production of physically stable beverages, and more particularly to physically stable high gravity fermented beverages such as beer.

### BACKGROUND ART

With respect to all beers—whether derived from high gravity beer or not—one important aspect of quality for beer drinkers is haze. In certain styles, such as hefeweizens and many craft beer styles, haze is acceptable or even desirable for the consumer. In other beer styles, such as a German Helles beer (meaning bright beer), the opposite is true and consumers find the presence of haze undesirable. Indeed, in the majority of beers consumed today, clarity is seen as a marker of quality in finished beer. A beer is considered to be haze-free under a turbidity of 2 EBC (European Brewers Convention units). EBC units are discussed in the context of other measurement standards at http://www.chemtronic-gmbh.de/index.php/techno-corner/79-ctr-english/98-turbidity-standards, as available on Jun. 19, 2017, which is attached hereto and incorporated herein by reference. Typically, therefore, it is uneconomical for a brewery to remove haze-causing constituents below the haze-free threshold of about 2 EBC. To achieve this clarity in their beers, brewers often allow haze to settle from their beers over time, or filter their beers using microfiltration or diatomaceous earth. Certain brewers may also add fining agents such as silica hydrogel, xero gel, bentonite, isinglass, PVPP, gelatin, copper, and/or Irish moss, amongst others. These fining agents precipitate out haze-causing compounds and produce a clear beer. However, if used in excess, these fining agents may strip out compounds giving beer its characteristic flavor.

In producing beer, it is common to first brew a beer that is of elevated alcohol content relative to the final beer product. This beer—known as high gravity beer—is typically is 6%-15% alcohol by volume (ABV). Thereafter the high gravity beer is typically de-brewed, through the addition of adjustment water, and introduction of carbonation to create a finished beer with alcohol by volume typically in the range of about 4% to 6% ABV. One benefit to brewers of this high gravity approach is that the size of the brew kettle needed for brewing a given amount of final beer product is smaller than when a beer is brewed directly to the final level of alcohol. For example, one hectoliter of high gravity beer, after de-brewing with adjustment water, might yield two hectoliters of final product. A second benefit of this high gravity method of brewing is transport efficiency. For example, high gravity beer may be produced in one location and then transported to another location, preferably closer to the consumer, where the high gravity beer is de-brewed with adjustment water and packaged for distribution.

On the other hand, one drawback of the high gravity method is that, the higher the alcohol concentration one tries to achieve during fermentation, the higher the stress upon the yeast, and the greater the impact upon flavor, and upon other characteristics important to the consumer, such as head retention. A less common method of producing a high gravity beer—which can circumvent issues of flavor faced in fermentation at high ABV—involves the use of membrane filtration to remove water from a lower alcohol beer to create a high gravity beer. Such a method is disclosed in PCT publication WO 2016/081399 A1, which is hereby incorporated herein by reference in its entirety. For example, one might take a beer at 6% ABV, adjust its water content, using reverse osmosis, to bring its concentration to 20% ABV. One might employ this approach for reasons of transport efficiency or for storage efficiency. In essence, the method allows for the production of a high gravity beer without needing to employ yeasts that can ferment to high alcohol levels but tend to impact flavor.

Methods for the control of haze in beers and high gravity beers produced via fermentation or high gravity fermentation are well known in the art. Often, beers are centrifuged or filtered via microfiltration (e.g., diatomaceous earth filters, cross-flow or dead-end membrane filters). Such processes, often practiced in conjunction with the prior addition of fining agents such as PVPP, allow for the removal of haze forming compounds such as proteins and polyphenol complexes. A reduced content of haze forming compounds in the beer delays the onset of haze as the beer ages over time. For example, a typical process might involve the addition of between 5 and 200 grams of fining agents per hectoliter of beer, subsequent centrifuging of the beer, followed by membrane filtration at between −2° C. and 4° C. to reduce the solubility of haze forming compounds, causing their precipitation and enabling their removal through filtration.

While the stabilization of conventionally brewed beers and high gravity beers is well understood, an understanding of conditions leading to the presence or absence of haze in high gravity beers (and resultant finished products) from processes involving water removal through membrane filtration is not present.

### SUMMARY OF THE EMBODIMENTS

Embodiments of the present invention are directed to systems and processes for achieving physically stable beverages, such as haze-free beverages.

The production of a high gravity beer through a process involving the removal of water from a beer via reverse osmosis can result in the formation of haze over time in the high gravity beer, and in a de-brewed final product that is derived therefrom. The presence of haze in a final beer product can be undesirable in filtered styles of lagers and ales that are crafted with brightness or brilliance in mind. In such styles of beer, the clarity of a lager is a signature of quality. Embodiments of the present invention address these circumstances.

In accordance with one embodiment of the invention, a method of reducing haze by creating a physically stable alcoholic beverage that has been obtained via filtration and separation processes includes receiving retentate from which water has been removed, from a reverse osmosis filter system having an initial alcoholic precursor to the alcoholic beverage in a feed stream, wherein concentration of alcohol in the retentate has reached between about 10% and 40% by volume, preferably between about 15% and 25% by volume, cooling the retentate to a temperature between about 2 degrees below a freezing point of the retentate and a freezing point of the initial alcoholic precursor to the alcoholic beverage in the feed stream, and then subjecting the retentate to a clarification process configured to remove particles having a size of about 0.4-0.8 microns and larger to produce a clarified retentate. The clarification process includes centrifuging, filtration using a filter, and/or forming a supernate and a precipitate and then decanting the supernate. The decanted supernate then becomes the clarified retentate that may be further processed, such as debrewed.

In related embodiments, the method may further include debrewing the clarified retentate after subjecting the retentate to the clarification process. This de-brewing may occur at the same or at a different location to the clarification. The retentate may be cooled between about 10 minutes and about 60 minutes, between about 10 seconds and about 24 hours, for up to 48 hours, or for up to 1 week before the clarification process. The alcoholic beverage may be beer, wine or cider. The cooling process may include cooling the retentate to a temperature of between about 2 degrees below the freezing point of the retentate (super-cooling) and about −2.5° C., or about −5° C. The method may further include adding a fining agent, such as polyvinylpolypyrrolidone, to the retentate before the clarification process. The method may further include debrewing the retentate by adding adjustment water after cooling the retentate and before subjecting the retentate to the clarification process.

In another embodiment, a method of reducing formation of haze by creating a physically stable alcoholic beverage subjected to filtration and separation processes includes extracting haze-causing constituents from a feed stream of the alcoholic beverage to produce a concentration of the haze-causing constituents of less than 80% of a first threshold that is sufficient to remove the presence of haze, receiving, from a reverse osmosis filter system having the alcoholic beverage in a feed stream, retentate from which water has been removed, wherein the concentration of alcohol in the retentate has reached about 10% to about 40% by volume, preferably about 15% to about 25% by volume, and debrewing the retentate. Optionally, the extraction of haze-causing constituents may occur (or also occur) from the retentate from the reverse osmosis unit. The haze-causing constituents may be extracted from the feed stream by adding fining agents, conditioning at a cold temperature (such as described herein), decanting, microfiltration, ultrafiltration and/or centrifuging.

In a further related embodiment, the concentration of the haze-causing constituents is less than 50% or even less than 20% of the first threshold. The method may further include subjecting the retentate to a clarification process configured to remove particles having a size of about 0.4-0.8 microns and larger before debrewing. The clarification process may include centrifuging, filtration using a filter, and/or forming a supernate and a precipitate and then decanting the supernate. The method may further include cooling the retentate, before subjecting the retentate to the clarification process, to a temperature between about 2 degrees below a freezing point of the retentate and a freezing point of the feed stream of the alcoholic beverage. The alcoholic beverage may be beer, and the method may further include cooling the retentate, before subjecting the retentate to the clarification process, to a temperature between about 2 degrees below the freezing point of the retentate to about −2.5° C. or −5.0° C. The cooling may include cooling the retentate between about 10 minutes and about 60 minutes, between about 10 seconds and about 24 hours, for up to 48 hours, or for up to a week before subjecting the retentate to the clarification process. The method may further include adding a fining agent, such as polyvinylpolypyrrolidone, to the retentate before the clarification process. The method may further include filtering the alcoholic beverage in the reverse osmosis filter system, wherein at least one membrane in the reverse osmosis filter system is substantially impermeable to ethanol but substantially permeable to water. The method may further include operating at least one membrane of the reverse osmosis filter system at a pressure of at least 1300 psi, at least 1500 psi, or at least 1800 psi. The method may further include operating the reverse osmosis filtration system to utilize at least a portion of a pressure of the retentate to drive the clarification process of the retentate. The filtration may include a filter, which may be a diatomaceous earth filter, a polymeric membrane filter and/or a ceramic filter.

Another embodiment includes a debrewed beverage made according to any of the methods recited above. The debrewed beverage may have an ABV of between 3% and 8%, and total haze of between 0.5 and 5 NTU using EBC method 9.41 or between 0.25 and 8 NTU using EBC method 9.41. Another embodiment includes a clarified retentate made according to any of the methods recited above.

In another embodiment, a system for reducing haze by creating a physically stable alcoholic beverage that has been obtained via filtration and separation processes includes a reverse osmosis filter system having a feed stream that receives an initial alcoholic precursor to the alcoholic beverage, and providing a retentate stream from which water has been removed, wherein the reverse osmosis filter system is configured to provide a concentration of alcohol in the retentate of between about 10% and 40% by volume, preferably between about 15% and 25% by volume, a clarification system having an input and an output, the input coupled to the retentate stream, the clarification system configured to remove particles having a size of about 0.4-0.8 microns and larger to produce a clarified retentate. The clarification system includes a filter, a centrifuge, and/or a decanter.

The system may further include a heat transfer section, disposed between the reverse osmosis system and the clarification system, or within the reverse osmosis system (e.g., between stages or passes), configured to cool the retentate before clarification to a temperature between about 2 degrees below a freezing point of the retentate and a freezing point of the initial alcoholic precursor to the alcoholic beverage in the feed stream. The system may further include a debrewer having an input configured to receive the clarified retentate derived from the clarification system output, the debrewer having an output to provide the processed alcoholic beverage. The heat transfer section may be configured to cool the retentate between about 10 minutes and about 60 minutes, between about 10 seconds and about 24 hours, for up to 48 hours, or for up to one week before the clarification. The system may be further configured to implement any of the methods described above.

### BRIEF DESCRIPTION OF THE DRAWINGS

The foregoing features of embodiments will be more readily understood by reference to the following detailed description, taken with reference to the accompanying drawings, in which:

FIG. 1 is a plot of turbidity (haze) measured in EBC units as a function ABV percentage in a retentate resulting from reverse osmosis filtration of beer to produce a high gravity beer.

FIG. 2 is a flow chart illustrating the path of the original beer through a reverse osmosis unit and further through a microfilter to produce a clarified retentate that is filtered in accordance with an embodiment of the present invention.

FIG. 3 is a flow chart illustrating haze removal using fining agents and a centrifuge to strip out haze-causing constituents, in accordance with another embodiment of the present invention, wherein the haze removal might be done, in some embodiments, before or after the reverse osmosis step.

### DETAILED DESCRIPTION OF SPECIFIC EMBODIMENTS

Definitions. As used in this description and the accompanying claims, the following terms shall have the meanings indicated, unless the context otherwise requires:

“Ultra-high gravity” wine or beer describes a retentate, of a reverse osmosis water removal process, applied to a wine or beer feed, that is higher in ethanol content than the feed to the process.

“Haze” in a beverage is the presence of visually observable particles in the beverage characterized by a turbidity of at least 2 EBC units. “EBC” stands for European Brewers Convention and is the primary unit used to measure beverage haze.

“Haze-causing constituents” are large polypeptides and polyphenols which interact to form hydrogen bonds, producing large particles characterizing haze.

“Permanent haze” occurs when haze-causing constituents interact for long periods of time and form permanent, covalent bonds rendering the haze insoluble.

A beverage is “haze-free” if the turbidity is less than 2 EBC.

“Debrewing” is the process of adding water to a beverage with a high alcohol by volume percentage, bringing that beverage to a commercially standard alcohol percentage.

“Tannins” are a subcategory of polyphenols that originate from plant tissue and are present in many alcoholic beverages. Tannins bind to and precipitate proteins and polypeptides. These are the primary family of polyphenols responsible for the formation of haze, while other polyphenols also contribute to the formation of haze.

“Adjustment water” is water employed to bring high gravity beer to the alcohol level of the finished beer. The water may be demineralized, purified using reverse osmosis or other technologies, deaerated and/or carbonated. Preferably, if the beer is to be packaged and distributed for consumption, the adjustment water should be microbe free, low in total dissolved solids (below 100 ppm) and low in oxygen (below 50 ppm, or even 10 ppm). If de-brewing is to occur at a bar (wherein, for example, high gravity beer may be provided in draft form), or at home (wherein, for example, high gravity beer may be provided in capsule form), it may be preferable to have water with minimal flavor, microbes or dissolved solids, but may be less important to have low oxygen content.

“NTU” is nephelometric turbidity units.

As used herein, “threshold” or “first threshold” refers to the EBC value for turbidity that brewers typically achieve using a combination of fining agents, centrifuging decanting, and/or filtration for beers that are not subjected to processing with reverse osmosis.

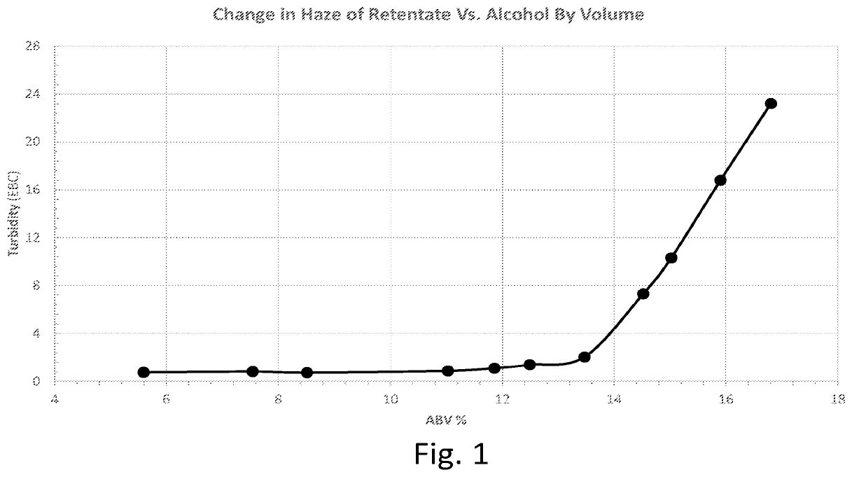

FIG. 1 is a plot of the change in turbidity (increase in haze) measured in EBC units as a function of ABV percentage in a retentate resulting from reverse osmosis filtration of beer to produce a high gravity beer. In this example, there was employed a reverse osmosis process, such as that depicted in PCT publication WO 2016/081399 A1, which is incorporated by reference herein in its entirety, with membranes that are substantially impermeable to ethanol but substantially permeable to water.

We have found, somewhat surprisingly, that haze appears in beer from which water has been removed by reverse osmosis, using the foregoing process, and appears, for example, when the concentration of alcohol in the retentate has reached about 10% to about 40% ABV or higher, as shown in FIG. 1.

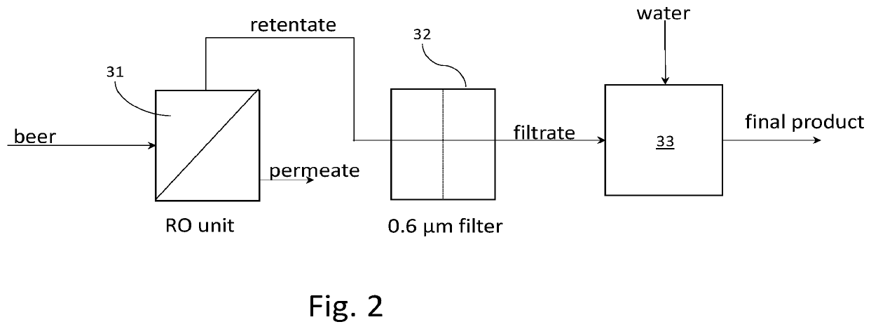

FIG. 2 is a flow chart illustrating the path of the original beer through a reverse osmosis unit and further through a clarification system (e.g., a microfilter) to produce a clarified retentate in accordance with an embodiment of the present invention. In FIG. 2, there is employed a reverse osmosis system 31, which is implemented in accordance with the teachings of published PCT application WO 2016/081399 A1. The retentate recovered from the reverse osmosis system 31 is high gravity beer, as described above. Thereafter, the high gravity beer retentate is subject to haze clarification through a clarification system 32 configured to remove particles having a size of about 0.6 microns and larger, such as a centrifuge, a filtration system having a filter, and/or a decanter that is configured to decant a supernate that is formed from the retentate. The clarified output of the clarification system 32 can then be shipped or otherwise handled as necessary. At some point prior to use, the high gravity beer clarified retentate is subjected to debrewing by debrewer 33, in which the high gravity beer is converted to the final product by the addition of adjustment water, which may also include carbon dioxide. A high gravity beer produced in this fashion can be transported more efficiently than the beverage in the feed stream, because it contains less water per unit volume. The high gravity beer may have improved microbial stability over the beverage in the feed stream, because the alcohol concentration by volume is higher.

Of note for the clarification of the high gravity beer is the size of the particles that the clarification system removes. For example, when the clarification system includes a filter, different types of filters may be employed, such as polymeric membranes, ceramic membranes, diatomaceous filters or filter presses, and these filters may be operated in cross-flow or dead-end modes. The size of particles that the clarification system removes may be in the range of visible light, i.e., about 0.4-0.8 microns, and larger. Preferably, to avoid the removal of flavor critical molecules and to achieve improved flows, the size of the particles that the clarification system removes may be in the range of about 0.5-0.6 microns and larger. An illustration of this system and process can be found in FIG. 2.

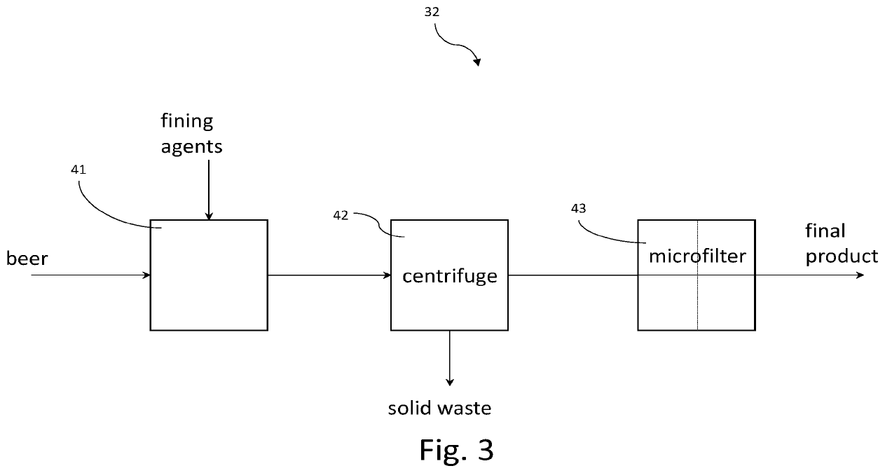

FIG. 3 is a flow chart illustrating haze removal using a clarification system 32 (e.g., fining agents 41, a centrifuge 42 to strip out haze-causing constituents, and a microfilter 43), in accordance with another embodiment of the present invention, wherein the haze removal is performed, in some embodiments, before or after the reverse osmosis step. Typically, it is common to reduce turbidity in clear beers until it has reached a threshold in the general vicinity of 2 EBC units and haze is acceptably removed. However, in accordance with embodiments of the present invention, the turbidity of the beer being subjected to reverse osmosis processing is reduced by a further amount below the threshold, for example reduced to 80% or 60% of the threshold. With preclarification and/or the extraction of haze-causing constituents before reverse osmosis processing, the tendency to form haze after reverse osmosis processing to produce high gravity beer and after debrewing of the high gravity beer is reduced. The clarification, in accordance with this embodiment, may be achieved by optionally blending fining agents 41 followed by processing in a centrifuge 42 and/or in a microfilter 43. Alternatively, or in addition, the clarification may form a supernate and a precipitate, and the supernate may then be separated from the precipitate giving a clarified retentate, e.g., a clarified ultra-high gravity beer.

Also as shown generally in FIG. 3, haze forming compounds may be removed from the fermented wort prior to or after reverse osmosis filtration, through the use of fining agents, such as silica hydrogel, xero gel, PVPP (polyvinylpolypyrrolidone), isinglass, Irish moss, gelatin, copper and bentonite as well as by mechanical methods such as centrifugation. Agents that are negatively charged are commonly added to precipitate out positively charged, haze-forming proteins while other fining agents are used to remove polyphenols from the beer. More specifically, PVPP may be added to the beer as an absorbent after the precursor beverage is subjected to reverse osmosis. One major benefit of PVPP is that it is not a beer additive and is completely removed out of the final product. This polymer is water and beer insoluble and has a high affinity for polyphenols. In accordance with another embodiment, PVPP polymers are added after or before reverse osmosis, to absorb polyphenols and separate haze causing molecules (polyphenols) out of solution. The PVPP polyphenol complex is then extracted with the use of a centrifuge 42 and/or a microfilter 43. The PVPP is then regenerated by rinsing with caustic cleaner. PVPP may also be used in a one-pot system, where the beer flows through a microfilter, followed by PVPP addition and then through a final filter to separate the PVPP from the clarified beer. The PVPP is then regenerated by flowing or reverse flowing a caustic solution through the second filter.

There are multiple ways to ensure a physically stable final product. One simple way is to clarify the final product after de-brewing at a temperature of between about −2 and 4° C., which may be done in combination with the addition of fining agents, filtration, decanting, and/or centrifugation. For example, beer or wine may be fermented and subsequently subjected to reverse osmosis at high pressures with membranes that are substantially impermeable to water to create an ultra-high gravity wine or beer. This wine or beer may be transported to a second location, where it is de-brewed and rendered physically stable through a combination of fining agent addition, centrifugation and/or filtration, such as microfiltration and/or ultrafiltration.

Another approach is to stabilize the ultra-high gravity beer via a combination of fining agent addition, decanting, centrifuging and/or filtration, such as microfiltration and/or ultrafiltration. Advantageously, since the freezing point of the ultra-high gravity beer is depressed or lowered as a result of the high concentration of ethanol, the ultra-high gravity beer may be stabilized at very low temperatures (e.g., about −25 to −2.5° C.) (called the UltraChill technique herein), reducing the solubility of haze forming compounds, and enhancing the precipitation of haze forming compounds, which may then be removed. For example, beer or wine may be fermented and subsequently subjected to reverse osmosis at high pressures with membranes that are substantially impermeable to water to create an ultra-high gravity (uHG) wine or beer. This uHG beer or wine may then be stored at very low temperatures in a climate-controlled tank for storage at temperatures near freezing. The aged retentate may be conditioned at these temperatures to encourage molecular interactions causing haze forming complexes of proteins and polyphenols. The conditioning may be performed for a period of time ranging from 10 seconds up to four weeks, preferably from about 10 minutes to about 60 minutes, after which haze may be removed via clarification, potentially also at very low temperatures. This process also may be expedited with the use of fining agents (such as Polyclar 10 or Daraclar 920) in the range of 5 to 200 grams per hectoliter. These haze forming complexes then may be separated through centrifugation or filtration, resulting in a haze free product. The potential benefit of this approach is to create a physically stable uHG beer or wine that may be shipped and then de-brewed (potentially at the point of consumption), without concerns around the formation of haze in the final product.

Features of embodiments of the present invention using this UltraChill technique are a) that water is removed from a beer to create an ultra-high gravity beer (uHG beer), b) that the uHG beer (uHGB) is chilled to a temperature that is within two to three degrees of its freezing point for a period between one second and one hour, more preferably between 10 minutes and 40 minutes, to form a supernate and a precipitate, and c) that the supernate is separated from the precipitate giving a clarified ultra-high gravity beer. The water removal may be achieved via a reverse osmosis process with membranes that are substantially impermeable to ethanol. Such a process may be batch or continuous and may involve multiple stages and/or multiple passes. One possible embodiment is described in PCT publication WO 2016/081399. The chilling may be conducted in a batch process or continuously. For example, the ultra-high gravity beer may be transferred to a jacketed brite tank, in which it is chilled. Alternately, the ultra-high gravity beer may be chilled via an inline heat exchanger. The chilled ultra-high gravity beer may be allowed to settle in a brite tank, and the supernate may be drawn off from the top of the tank. Alternately, the precipitate may be drawn off from the bottom of the tank. Generally, to minimize product losses, it is advantageous to subject the precipitate (and optionally the supernate) to a centrifuging processes in order to recover further beer. Centrifuging the entire chilled ultra-high gravity beer is also a good approach for generating a clarified product while minimizing losses. It is also important that each step be conducted anaerobically to avoid oxidation of the product. To obtain the best flavor profile, it may be advantageous to blend a portion of the precipitate with the supernate. This will increase product haze but may offer sensory benefits. Further, it may be beneficial to subject the supernate to ultra-filtration or filtration with diatomaceous earth in order to further reduce haze.

### EXAMPLES

Water was removed from a lager to create an ultra-high gravity lager of 18-22% ABV, by employing a reverse osmosis process with membranes that were substantially impermeable to ethanol. A portion of the original lager was set aside as a control (the “control”).

A portion of the ultra-high gravity lager was de-brewed, using de-aerated water, to roughly the same gravity as the control (the “ultra-high gravity trial” or “uHG trial”).

Another portion of the ultra-high gravity lager was chilled to a temperature of −18 deg C. (very close to freezing point) and maintained at that temperature for 30 minutes. Rapid precipitation was observed as the temperature approached the freezing point, and the high gravity lager formed a supernate (low in haze) and a precipitate (high in haze). The supernate was decanted and de-brewed, using de-aerated water, to roughly the same gravity as the control (the “clarified ultra-high gravity trial” or “C-uHG trial”).

Measurements of permanent and chill haze were taken on the control, ultra-High Gravity (uHG) Trial and the Clarified High Gravity (C-uHG) Trial samples using the EBC method 9.41, and results are reported in Table 1 below.

TABLE 1
Physical Stability of Control and Trial Beers
(*normalized by dividing by ABV of the Control)

| | Beer 1 | | | Beer 2 | | |
|---|---|---|---|---|---|---|
| | | uHG | C-uHG | | uHG | C-uHG |
| | Control | Trial | Trial | Control | Trial | Trial |
| Alcohol by volume* | 1 | 0.67 | 0.65 | 1 | 0.67 | 0.64 |
| Permanent Haze | 1.4 | 7.4 | 1.1 | 1.5 | 4.7 | 0.49 |
| [NTU] | | | | | | |
| Chill Haze [NTU] | 158.6 | 16.5 | 0.4 | 127.5 | 2.9 | 1.6 |
| Total Haze [NTU] | 160 | 23.9 | 1.4 | 129 | 7.6 | 2.0 |

Beer 1 in Table 1 was then aged at 55° C. for five days and haze was measured using EBC method 9.41. Total haze remains lowest in the clarified uHG trial sample after aging, illustrating improved physical stability via the UltraChill method. The decrease in chill haze of the samples after aging may be due to a higher measurement temperature of the aged samples, measured after the samples were cooled from 55° C. The decrease may also result from the solubilizing of compounds at the higher temperature. Results are reported in Table 2.

TABLE 2
Physical Stability of Control and Trial Beers
(*normalized by dividing by ABV of the Control)

| | Before aging | | | After Aging | | |
|---|---|---|---|---|---|---|
| | | uHG | C-uHG | | uHG | C-uHG |
| | Control | Trial | Trial | Control | Trial | Trial |
| Alcohol by volume* | 1 | 0.67 | 0.65 | 1 | 0.67 | 0.65 |
| Permanent Haze | 1.4 | 7.4 | 1.1 | 1.1 | 2.9 | 0.92 |
| [NTU] | | | | | | |
| Chill Haze [NTU] | 158.6 | 16.5 | 0.4 | 212.9 | 82.9 | 12.5 |
| Total Haze [NTU] | 160 | 23.9 | 1.4 | 214 | 85.8 | 13.4 |

The embodiments of the invention described above are intended to be merely exemplary; numerous variations and modifications will be apparent to those skilled in the art. All such variations and modifications are intended to be within the scope of the present invention as defined in the appended claims.

1. A method of reducing haze by creating a physically stable alcoholic beverage that has been obtained via filtration and separation processes, the method comprising:
receiving retentate from which water has been removed, from a reverse osmosis filter system having an initial alcoholic precursor to the alcoholic beverage in a feed stream, wherein a concentration of alcohol in the retentate has reached between about 10% and 40% by volume;
cooling the retentate to a temperature between about 2 degrees below a freezing point of the retentate and a freezing point of the initial alcoholic precursor to the alcoholic beverage in the feed stream; and
subjecting the retentate to a clarification process configured to remove particles having a size of about 0.4-0.8 microns and larger to produce a clarified retentate, the clarification process including (a) centrifuging, (b) filtration using a filter, and/or (c) forming a supernate and a precipitate and then decanting the supernate.

2. A method according to claim 1, further comprising:
debrewing the clarified retentate after subjecting the retentate to the clarification process.

3. A method according to claim 1, wherein the alcoholic beverage is beer, and
the cooling includes cooling the retentate between about 2 degrees below the freezing point of the retentate to about −2.5° C.

4. (canceled)

5. A method according to claim 1, wherein the cooling includes cooling the retentate between about 10 seconds and about 24 hours before subjecting the retentate to the clarification process.

6. (canceled)

7. A method according to claim 1, wherein the cooling includes cooling the retentate for up to one week before the clarification process.

8. A method according to claim 1, further comprising adding a fining agent to the retentate before the clarification process.

9. (canceled)

10. A method according to claim 1, further comprising:
filtering the alcoholic beverage in the reverse osmosis filter system, wherein at least one membrane in the reverse osmosis filter system is substantially impermeable to ethanol but substantially permeable to water.

11. A method according to claim 1, further comprising operating at least one membrane of the reverse osmosis filter system at a pressure of at least 1800 psi.

12. (canceled)

13. A method according to claim 1, further comprising operating the reverse osmosis filtration system to utilize at least a portion of a pressure of the retentate to drive the clarification process of the retentate.

14. (canceled)

15. (canceled)

16. (canceled)

17. (canceled)

18. A debrewed beverage made according to the method of claim 1 having an ABV of between 3% and 8%, and total haze of between 0.25 and 8 NTU using EBC method 9.41.

19. A clarified retentate made according to the method of claim 1.

20. A system for reducing haze by creating a physically stable alcoholic beverage that has been obtained via filtration and separation processes, the system comprising:
a reverse osmosis filter system having a feed stream that receives an initial alcoholic precursor to the alcoholic beverage, and providing a retentate stream from which water has been removed, wherein the reverse osmosis filter system is configured to provide a concentration of alcohol in the retentate of between about 10% and 40% by volume;
a clarification system having an input and an output, the input coupled to the retentate stream, the clarification system configured to remove particles having a size of about 0.4-0.8 microns and larger to produce a clarified retentate, the clarification system comprising a filter and/or a centrifuge; and
a heat transfer section, disposed between the reverse osmosis system and the clarification system or within the reverse osmosis system, configured to cool the retentate before clarification to a temperature between about 2 degrees below a freezing point of the retentate and a freezing point of the initial alcoholic precursor to the alcoholic beverage in the feed stream.

21. (canceled)

22. A system according to claim 20, wherein the heat transfer section is configured to cool the retentate between 10 seconds and 24 hours or more before the clarification.

23. A method of reducing formation of haze by creating a physically stable alcoholic beverage subjected to filtration and separation processes, the method comprising:
extracting haze-causing constituents from a feed stream of the alcoholic beverage to produce a concentration of the haze-causing constituents of less than 80% of a first threshold that is sufficient to remove the presence of haze;
receiving, from a reverse osmosis filter system having the alcoholic beverage in the feed stream, retentate from which water has been removed, wherein a concentration of alcohol in the retentate has reached about 10% to about 40% by volume; and
debrewing the retentate.

24. A method according to claim 23, wherein the concentration of the haze-causing constituents is less than 50% of the first threshold.

25. (canceled)

26. (canceled)

27. (canceled)

28. (canceled)

29. (canceled)

30. (canceled)

31. (canceled)

32. (canceled)

33. (canceled)

34. (canceled)
